(19) United States
(12) Patent Application Publication
(10) Pub. No.: US 2012/0181250 A1
(43) Pub. Date: Jul. 19, 2012

(54) INFRARED LASER WELDING OF PLASTIC PARTS WITH ONE OR MORE OF THE PARTS HAVING A MODIFIED SURFACE PROVIDING INCREASED ABSORBTIVITY TO INFRARED LASER LIGHT

(75) Inventor: Robert Jalbert, Mountain Top, PA (US)

(73) Assignee: Branson Ultrasonics Corporation, Danbury, CT (US)

(21) Appl. No.: 13/349,619

(22) Filed: Jan. 13, 2012

Related U.S. Application Data
(60) Provisional application No. 61/433,308, filed on Jan. 17, 2011.

(51) Int. Cl. B32B 37/06; B32B 37/24; B32B 38/00

(52) U.S. Cl. 216/34; 156/272.8; 156/242

(57) ABSTRACT

A method of using TTIr welding to weld together two high transmissivity plastic parts includes providing one or both parts with a modified surface that increases that plastic part's absorbtivity to laser light. The two parts are then laser welded by directing a beam of infrared laser light to the parts which are oriented so that the beam of infrared laser light first passes through one of the parts, impinges the modified surface (or surfaces) at a weld interface where the two plastic parts abut each other to melt the plastic parts at the weld interface, and then passes through the other plastic part.

### CROSS-REFERENCE TO RELATED APPLICATIONS

This application claims the benefit of U.S. Provisional Application No. 61/433,308, filed on Jan. 17, 2011. The entire disclosure of the above application is incorporated herein by reference.

### FIELD

The present invention relates to plastic welding, and more particularly to laser welding of plastic parts.

### BACKGROUND

Laser welding is commonly used to join plastic or resinous parts, such as thermoplastic parts, at a welding zone. An example of such use of lasers can be found in U.S. Pat. No. 4,636,609, which is expressly incorporated herein by reference.

As is well known, lasers provide a semi-focused beam of electromagnetic radiation at a specified frequency (i.e., coherent monochromatic radiation). There are a number of types of lasers available; however, infrared lasers or non-coherent sources provide a relatively economical source of radiative energy for use in heating a welding zone. One particular example of infrared welding is known as through-transmission infrared (TTIr) welding. TTIr welding employs an infrared laser capable of producing infrared radiation that is directed by lenses, diffractive optics, fiber optics, waveguides, lightpipes, or lightguides through a first plastic part and into a second plastic part. This first plastic part is often referred to as the transmissive piece, since it generally permits the laser beam from the laser to pass therethrough. However, the second plastic part is often referred to as absorptive piece, since this piece (and/or an absorbtive additive at the weld interface) generally absorbs the radiative energy of the laser beam to produce heat in the welding zone. This heat in the welding zone causes the transmissive piece and the absorptive piece to be melted and, with intimate contact, welded together.

With reference to FIGS. 1A and 1B, typical through transmission infrared (TTIr) systems 100 and 100′ for laser welding of plastics are shown. A beam of infrared laser light 102 from a source of infrared laser light 104 is directed to the plastic parts 106, 108 to be welded. The infrared laser light passes through transmissive plastic part 106 to a weld interface 110 at a junction of transmissive plastic part and absorptive plastic part 108. Weld interface 110 is also sometimes referred to in the art as a weld site, a weld region or a weld area. An infrared absorber additive 112 may be provided at weld interface 110 (FIG. 1A). The absorption of the laser light heats up the weld interface at the junction of the parts 106, 108, melting the plastic in both parts 106, 108 at the weld interface 110. The laser light is removed, such as by turning laser source 102 off, after an appropriate period of time and the molten plastic at weld interface 110 then cools, thus welding the two plastic parts 106, 108 together.

Oftentimes, the plastic parts are a relatively low absorber of the infrared light, particularly in cases where the second plastic part is made of the same material as the first plastic part and both plastic parts have a color having high transmissivity to infrared laser light, such as being clear or relatively clear. The infrared absorber additive used at the weld interface may also be a relatively low absorber of the infrared light. Further, in some cases, the infrared absorber additive cannot be used.

With low absorbers, either too low a laser energy is delivered to the weld interface to make a weld, or relatively high laser energies need to be used to translate into enough energy at the weld interface to make a weld.

### SUMMARY

In accordance with an aspect of the present disclosure, two high transmissivity plastic parts are laser welded together using infrared laser welding. One or both of the plastic parts has a modified surface that increases the absorbtivity to infrared laser light of the plastic part having the modified surface at the modified surface. The two plastic parts are then laser welded by directing a beam of infrared laser light to the plastic parts which are oriented so that the beam of infrared laser light passes through one the plastic parts, impinges the modified surface or surfaces at a weld interface where the plastic parts abut each other, and then passes through the other plastic part. The modified surface or surfaces increase the absorbtivity of infrared laser light of the plastic part or parts at the weld interface to melt the plastic parts at the weld interface so as to weld them together.

In an aspect, the surface of each part to be modified is modified by roughening. In an aspect, roughening is mechanical roughening. In an aspect, the surface of each part to be modified is modified by etching. In an aspect, etching is laser etching. In an aspect, etching is chemical etching. In an aspect, the surface of each part to be modified is modified by laser burning that discolors that surface. In an aspect, the surface the surface of each part to be modified is modified by laser etching to roughen that surface and that also burns that surface to discolor it.

In an aspect, each part having a modified surface is formed to have the modified surface. In an aspect, each part having a modified surface is molded to have roughened surface that is the modified surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIGS. 1A and 1B are schematic illustrations of prior art low absorption TTIr laser welding systems for welding plastic parts with infrared laser light;

FIG. 2 is a schematic illustration of two plastic parts being welded in an infrared laser welding system in accordance with an aspect of the present disclosure; and

FIG. 3 is a perspective view of one of the plastic parts of FIG. 2 having a roughened surface.

### DETAILED DESCRIPTION

The following description of the preferred embodiment(s) is merely exemplary in nature and is in no way intended to limit the invention, its application, or uses.

With reference to FIG. 2, two plastic parts 200, 202 to be welded together by infrared laser welding are shown. In the illustrative example of FIG. 2, both plastic parts 200, 202 are made of plastic material having high transmissivity (and thus low absorbtivity) to the infrared laser light. They also each have a color that has high transmissivity (and thus low absorbtivity) to the infrared laser light. In an example, both plastic parts are made of the same plastic material and are clear or relatively clear. It should be understood that either or both the plastic parts could be pigmented to have a color other than clear or relatively clear and may not be the same color.

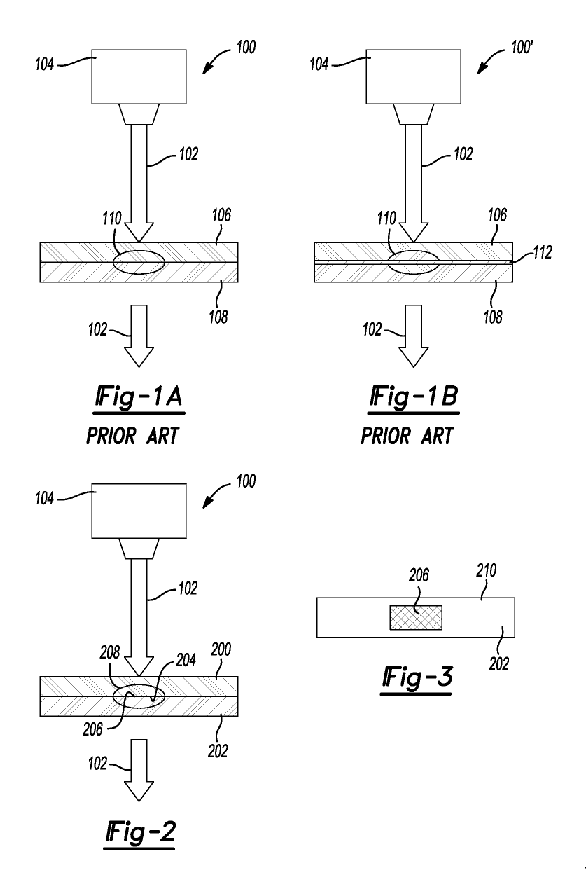

When parts 200, 202 are welded, they are positioned in an infrared laser welding system, such as infrared laser welding system 100 of FIG. 1, so that a surface 204 of part 200 and a surface 206 of part 202 abut each other, with the junction of the surfaces 204, 206 being a weld interface 208 at which the parts 200, 202 are welded together. One or both surfaces 204, 206 is a modified surface that has characteristics that differ from characteristics of a surface of the plastic part surrounding the modified surface and provide the plastic part 200, 202 with increased absorbtivity to infrared laser light at the modified surface compared to the area of the plastic part surrounding the modified surface that lacks the different characteristics of the modified surface. The term “modified surface” herein means a surface of a plastic part having different characteristics from an area of the plastic part surrounding the modified surface where the different characteristics provide the plastic part with increased absorbtivity to infrared laser light compared to the area surrounding the modified surface that does not have the different characteristics. Each modified surface (or surfaces) 204, 206 blocks enough of the infrared laser light (thus effectively increasing absorbtivity) to generate enough heat at weld interface 208 to melt plastic parts 200, 202 at weld interface 208 so as to weld them together. In this regard, the absorbtivity of laser light needed is a function of the melting temperature of the material of which the parts are made and the amount/wavelength of laser light needed to melt the material. This may, for example, be determined heuristically for the parts being welded. In the example shown in FIG. 3, surface 206 of part 202 is a modified surface.

The modified surface (or surfaces) 204, 206 can be provided in any manner that sufficiently alters the characteristics of the surface of the plastic part to increase the absorbtivity of infrared laser light to melt the plastic parts 200, 202 at the weld interface 208 so as to weld them together. In an aspect, the surface (or surfaces) 204, 206 is modified after the respective part 200, 202 has been formed to provide the modified surface. In an aspect, the surface (or surfaces) 204, 206 is modified by roughening. In an aspect, the surface (or surfaces) 204, 206 is roughened by etching, such as laser etching or chemical etching. In an aspect, the surface (or surfaces) 204, 206 is modified by laser burning the surface (or surfaces) 204, 206 to discolor it. In an aspect, the surface (or surfaces) 204, 206 is also modified by laser etching. In an aspect, the surface (or surfaces) 204, 206 is roughened by mechanical roughening, such as grinding, sanding, or other mechanical abrasion.

In an aspect, the modified surface (or surfaces) 204, 206 is provided by forming the plastic part (or parts) 200, 204 having the modified surface so that surface (or surfaces) 204, 206 has the different characteristics. For example, if the part is formed by molding, the part is molded so that the modified surface (or surfaces) 204, 206 is a roughened surface. That is, the modified surface (or surfaces) 204, 206 is rougher than a surface (such as surface 210 of part 202 in FIG. 3) surrounding the modified surface (or surfaces) 204, 206.

When parts 200, 202 are welded in an infrared laser welding system, such as infrared laser welding system 100 of FIG. 1, they are positioned so that a beam of infrared laser light will first pass through one of the parts 200, 202, impinge on the modified surface (or surfaces) 204, 206 at weld interface 208, and then pass through the other part 200, 202. In this regard, parts 200, 202 are placed together so that surfaces 204, 206 of parts 200, 202 abut each other. As discussed, the modified surface (or surfaces) 204, 206 blocks a sufficient amount of the infrared laser light to generate enough heat at weld interface 208 to melt parts 200, 202 at weld interface 208 welding them together.

When laser etching and/or burning is used to modify the surface (or surfaces) 204, 206 of parts 200, 202, the same infrared welder that is used to weld the parts 200, 202 can also be used to etch and/or burn the surface (or surfaces) 204, 206.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of welding two plastic parts together using through-transmission infrared welding, comprising:
providing the two plastic parts where both plastic parts have high transmissivity to infrared laser light and at least one of the plastic parts has a modified surface that increases the absorbtivity of the plastic part having the modified surface to infrared laser light at the modified surface;
placing the two plastic parts together so that the modified surface of the plastic part having the modified surface abuts a surface of the other plastic part at a weld interface; and
then directing a beam of infrared laser light to the two plastic parts so that the beam of infrared laser light first passes through one of the plastic parts, impinges the modified surface at the weld interface, and then passes through the other plastic part.

2. The method of claim 1 wherein providing the two plastic parts where at least one of the plastic parts has the modified surface includes providing them where each of the plastic parts has a modified surface that increases the absorbtivity of the plastic part having the modified surface to infrared laser light at the modified surface.

3. The method of claim 1 wherein providing the plastic parts includes modifying the surface of each plastic part that is to have the modified surface after the plastic part has been formed.

4. The method of claim 3 wherein modifying the surface of each plastic part that is to have the modified surface includes mechanically roughening the surface of that plastic part.

5. The method of claim 3 wherein modifying the surface of each plastic part that is to have the modified surface includes laser etching the surface of that plastic part or laser burning the surface of that plastic part to discolor that surface.

6. The method of claim 3 wherein modifying the surface of each plastic part that is to have the modified surface includes laser etching the surface of that plastic part and laser burning the surface of that plastic part to discolor that surface.

7. The method of claim 3 wherein modifying the surface of each plastic part that is to have the modified surface includes chemically etching the surface of that plastic part.

8. The method of claim 1 including forming each plastic part that is to have the modified surface with the modified surface.

9. The method of claim 8 wherein forming each plastic part that is to have the modified surface includes including molding that plastic part with the modified surface wherein the modified surface is surface that is rougher than a surface of the plastic part surrounding the modified surface.
